(19) United States
(12) Patent Application Publication
(10) Pub. No.: US 2003/0188970 A1
(43) Pub. Date: Oct. 9, 2003

(54) Electrophoresis separation apparatus and its used a hand-held electrophoresis detection device

(75) Inventors: Chung-Fan Chiou, Hsinchu (TW); Chih-Wei Ho, Miaoli (TW); Bor-Iuan Jan, Pingtung (TW); Chun-Ju Chang, Taichung (TW); Jia-Huey Tsao, Hsinchu (TW); Chao-Chih Pan, Hsinchu (TW)

Correspondence Address: SUGHRUE MION, PLLC, 2100 PENNSYLVANIA AVENUE, N.W., WASHINGTON, DC, 20037, US

(73) Assignee: INDUSTRIAL TECHNOLOGY RESEARCH INSTITUTE

(21) Appl. No.: 10/273,273

(22) Filed: Oct. 18, 2002

(30) Foreign Application Priority Data
Apr. 4, 2002 (TW) 91106870

(51) Int. Cl. G01N 27/27

(52) U.S. Cl. 204/603

(57) ABSTRACT

An electrophoresis separation apparatus using a hand-held electrophoresis detection device. The hand-held electrophoresis detection device includes a body and a cartridge disposed on the body in a detachable manner, and provided with at least one detecting column. The electrophoresis separation apparatus detect samples, and comprises a main portion and the hand-held electrophoresis detection device. The main portion controls the process of sample-detecting. The hand-held electrophoresis detection device is electrically coupled to the main portion in a separable manner. The detecting column is provided with a first end and a second end. The first end is provided with a first voltage, and the second end is provided with a second voltage. The sample is attached to the second end of the detecting column. The sample moves from the second end to the first end through the detecting column by a voltage differential between the first voltage and the second voltage.

### BACKGROUND OF THE INVENTION

1. Field of the Invention

The invention relates to an electrophoresis separation apparatus; in particular, to an electrophoresis separation apparatus with a hand-held electrophoresis detection device.

2. Description of the Related Art

The value of electrophoresis in clinical chemistry has been recognized for some time in the analysis, for example, of proteins in serum as well as other body fluids. Typically, gel electrophoresis is the method of choice in clinical chemistry laboratories.

FIG. 1 shows a conventional gel electrophoresis apparatus 10. The apparatus 10 comprises a separation tank 11, and a power supply 12 electrically coupled to the separation tank 11. During analysis, a sample is applied near one edge of a layer of gelatin carried on a flexible sheet, usually called a “gel” 13. The gel 13 is disposed in the separation tank 11, and is electrophoresis by the power supply 12, stained and the density of the resulting pattern is measured to reveal the proteins contained in the sample.

Although gel electrophoresis is relatively inexpensive in terms of the supplies and equipment required to perform sample analyses, the technique requires skilled technicians and is time consuming, effectively resulting in a high price per test and limiting the number of tests that can be performed using the technique.

Efforts have been made to automate electrophoresis in the clinical laboratory. For example, capillary electrophoresis is a more recent development and can be used to perform the type of electrophoresis separations presently performed with gels. In capillary electrophoresis, a small tube or capillary having an inside bore diameter in the range of about five microns to about two hundred microns and often about twenty cm long is filled with an electrically conductive fluid, or buffer. A small quantity of a sample to be analyzed is introduced into one end of the capillary bore and the ends of the capillary are placed into separate reservoirs of buffer. A direct current voltage in a range of about 2,000 volts to about 30,000 volts is applied to the ends of the capillary by means of electrodes positioned in the buffer reservoirs, causing a small current, typically in the range of about five micro amps to about one milliamp, to flow through the capillary. With the correct polarity applied across the capillary, the sample begins to migrate from the sample introduction end toward the other end of the capillary. As this migration occurs, different molecules in the sample travel at different rates primarily because of slightly different electrical charges on the molecules. These different migration rates cause molecules with slightly different charges to separate one from the other, some moving more quickly and advancing relatively with respect to more slowly moving molecules. As the sample nears the other end of the capillary, the small volume of sample becomes separated into bands of different molecules according to the relative migration rates of the molecules. These bands or groups of different molecules are detected near the other end of the capillary by, for example, passing a light beam through the bore of the capillary. Changes to the light beam, such as absorbance caused by the different molecules, are detected as the separated molecules pass through the beam, thus identifying the different molecules or the classes or categories of molecules in the sample and the relative concentration of such molecules.

Automated forms of capillary electrophoresis analyzers are known in the art. For example, FIG. 2 shows a conventional capillary electrophoresis analyzer 20 described in U.S. Pat. No. 5,560,811. An electrophoresis separation plate 21 has a plurality of sample wells 22 at one end and a common buffer reservoir 23 at the other end. A first master electrode 25 is electrically connected to a cell electrode 26 in the sample wells 22. A second master electrode 27 is in the common buffer reservoir 23. Capillary electrophoresis columns 28 are mounted in the plate 21 so that there is electrical communication between the first master electrode 25 by way of the capillary electrophoresis column 28 when the sample wells 22 and the reservoir 23 are filled with electrically conductive liquid. In operation, current between the master electrodes permits electrophoresis of the sample from the sample well 22 to the reservoir 23.

Other automated capillary electrophoresis apparatuses are described in U.S. Pat. No. 6,132,582, U.S. Pat. No. 5,885,430, U.S. Pat. No. 6,118,127, U.S. Pat. No. 5,413,686.

None of the automated analyzers described, however, are suitable for routine clinical laboratory applications. Each requires considerable manual manipulation despite their automated nature, such as preparation and placement of individual sample and buffer vials onto the analyzer, programming for the various analytical routines, and the like. Because only one sample can be electrophoresis and detected during each analysis cycle of the analyzers, the number of samples per unit time, or throughput, is severely restricted as compared to the needs of most routine clinical laboratory work.

Yet another disadvantage of conventional analyzers is that it appears difficult to replace the capillary, thereby adding to the expense and inconvenience of use in a clinical chemistry environment.

Thus, there is a need for an automated capillary electrophoresis analyzer that is easy to use, requires less sample manipulation, is relatively inexpensive, and is capable of substantially increased throughput as compared to prior capillary electrophoresis analyzers. There is also a need for an automated capillary electrophoresis analyzer that can be easily adapted for use in a clinical chemistry laboratory.

### SUMMARY OF THE INVENTION

In order to address the disadvantages of the aforementioned electrophoresis analyzer, the invention provides an electrophoresis separation apparatus with a hand-held electrophoresis detection device to enhance convenience.

Another purpose of this invention is to provide a hand-held electrophoresis detection device with a replaceable cartridge to prevent samples from intermixing.

Accordingly, the invention provides an electrophoresis separation apparatus for detecting samples. The apparatus comprises a main portion and a hand-held electrophoresis detection device. The main portion controls a detection of the sample. The hand-held electrophoresis detection device, connected with the main portion in a separable manner, includes at least one detecting column. The detecting column includes a first end and a second end, and has a first voltage at the first end and a second voltage at the second end. The sample is attached to the second end of the detecting column. Thus, the sample moves from the second end to the first end through the detecting column by a voltage differential between the first voltage and the second voltage.

In a preferred embodiment, the main portion comprises a power supply, a controller, an input panel, and a display. The power supply, electrically coupled to the detecting column, provides the first voltage and the second voltage. The controller is electrically coupled to the power supply to control power supply. The input panel, electrically coupled to the controller, inputs a predetermined data. The display is electrically coupled to the controller.

It is understood that the controller, the input panel, and the display can be replaced by a computer.

In another preferred embodiment, the electrophoresis separation apparatus further comprises a robot. The robot is electrically coupled to the main portion to move the hand-held electrophoresis detection device to a predetermined position.

In another preferred embodiment, the hand-held electrophoresis detection device includes a standard column for comparing with the detecting column.

In another preferred embodiment, the hand-held electrophoresis detection device comprises a body, a cartridge, and a sensor. The body is electrically coupled with the main portion. The cartridge, disposed on the body, includes the detecting column. The sensor, disposed in the body, detects a movement of the sample in the detecting column.

Furthermore, the sensor may be an optical sensor, such as a photodiode.

It is understood that a labeling reagent can be attached to the sample to assist the sensor in detecting the sample. The labeling reagent comprises fluorescent molecules or nanometer-scale particles or light-absorbent molecules.

Furthermore, the electrophoresis separation apparatus comprises a light source for providing a light when the sensor detects the sample.

Furthermore, the body includes a slot for receiving the cartridge so that the cartridge is disposed in the slot of the body in a detachable manner.

Furthermore, the first end of the detecting column is electrically coupled to the body to carry the first voltage.

Furthermore, the hand-held electrophoresis detection device comprises an auxiliary base disposed on the body in a detachable manner.

Furthermore, the second end of the detecting column is electrically coupled to the auxiliary base to carry the second voltage.

In another preferred embodiment, this invention provides a hand-held electrophoresis detection device for detecting samples. The detecting device comprises a body, a cartridge, and a sensor. The cartridge, disposed on the body, includes at least one detecting column. The detecting column includes a first end and a second end, and has a first voltage at the first end and a second voltage at the second end. The sample is attached to the second end of the detecting column. Thus, the sample moves from the second end to the first end through the detecting column by a voltage differential between the first voltage and the second voltage. The sensor, disposed in the body, detects a movement of the sample in the detecting column.

### BRIEF DESCRIPTION OF THE DRAWINGS

The invention is hereinafter described in detail with reference to the accompanying drawings in which:

FIG. 1 is a schematic view of a conventional gel electrophoresis apparatus;

FIG. 2 is a schematic view of a conventional capillary electrophoresis analyzer as described in U.S. Pat. No. 5,560,811;

FIG. 3 is a schematic view of an electrophoresis separation apparatus as disclosed in this invention;

FIG. 4 is a schematic view that shows a sensor and a cartridge in FIG. 3;

FIG. 5 is a schematic view that shows a detecting column in FIG. 3;

FIG. 6 is a schematic view that shows a detecting column and an auxiliary base in FIG. 3;

FIG. 7 is a schematic view of a variant embodiment of the electrophoresis separation apparatus in FIG. 3; and

FIG. 8 is schematic view that shows the electrophoresis separation apparatus, shown in FIG. 7, applied in a normal assay plate.

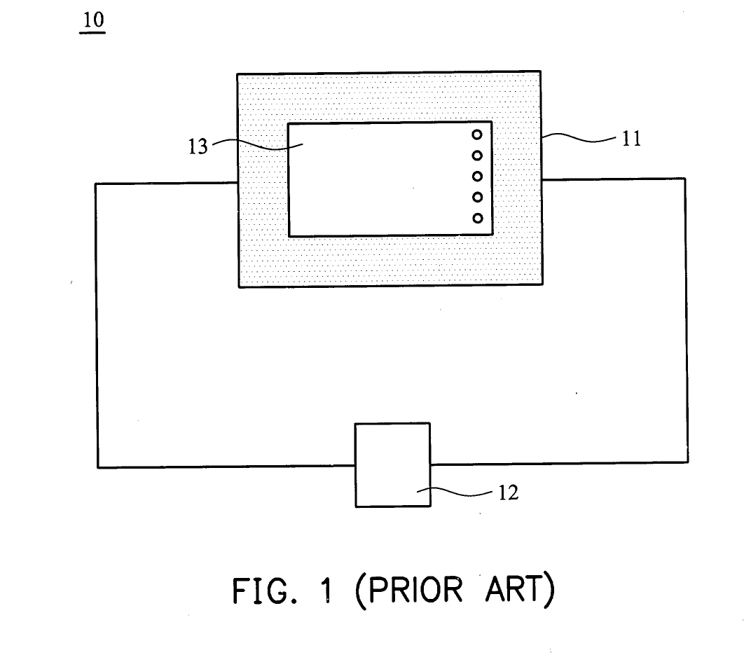

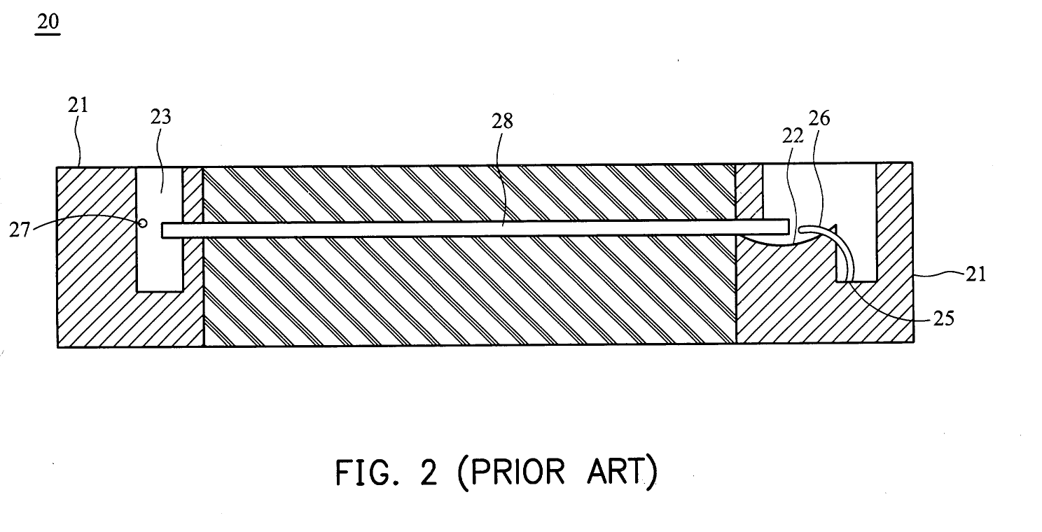

### DETAILED DESCRIPTION OF THE INVENTION

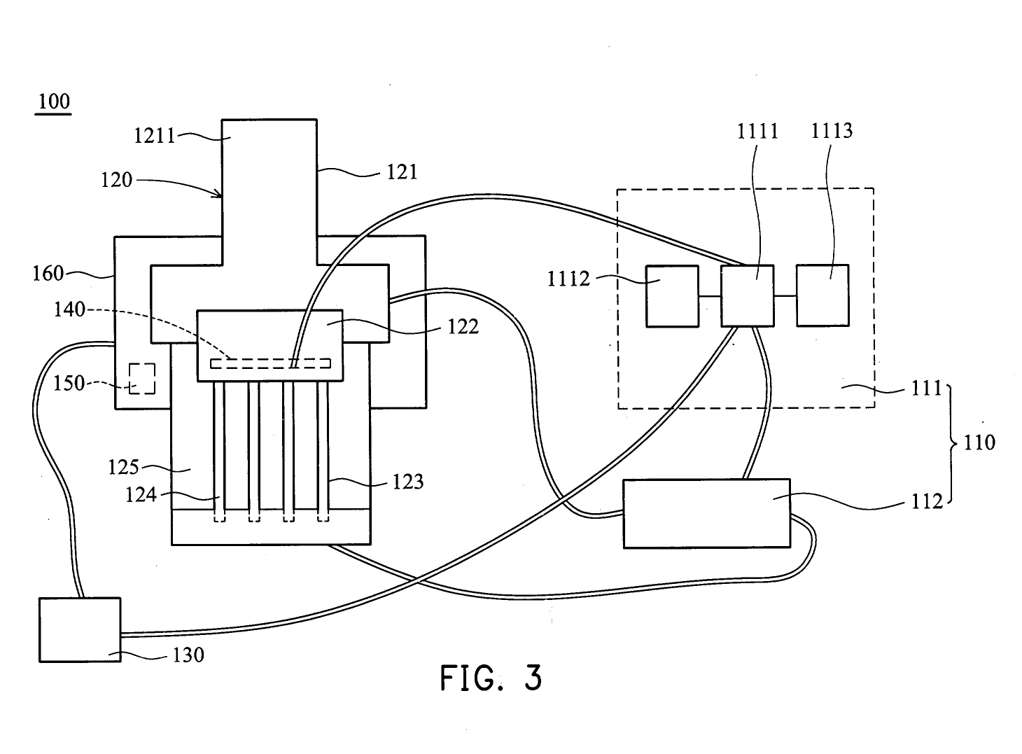

Referring to FIG. 3, an electrophoresis separation apparatus 100, as disclosed in this invention, is applied for normal biochemical analysis to detect samples. The electrophoresis separation apparatus 100 comprises a main portion 110, a hand-held electrophoresis detection device 120, a robot 130, a sensor 140, a light source 150, and a housing 160.

The main portion 110 is used as a body of the electrophoresis separation apparatus 100, and controls the whole process of the sample-detection. The main portion 110 comprises a power supply 112, a controller 1111, an input panel 1112, and a display 1113. The power supply 112 is electrically coupled to the controller 1111 and the hand-held electrophoresis detection device 120 to provide a predetermined voltage differential to the hand-held electrophoresis detection device 120. The controller 1111 is used as a body of the main portion 110, and is electrically coupled to the hand-held electrophoresis detection device 120 and the power supply 112. The controller 1111 controls the power supply 112 and processes the data obtained in biochemical analysis. The input panel 1112, electrically coupled to the controller 1111, inputs a predetermined data. The display 1113 is electrically coupled to the controller 1111 to display the data obtained in biochemical analysis.

It is understood that the controller 1111, the input panel 1112, and the display 1113 can be replaced by a normal computer 111 with the above function.

The hand-held electrophoresis detection device 120 is connected with the main portion 110 in a separable manner. Thus, the operator can freely hold the hand-held electrophoresis detection device 120 without the limitation of the main portion 110; that is, the hand-held electrophoresis detection device 120 can detect the samples away from the main portion 110. The hand-held electrophoresis detection device 120 includes a body 121, a cartridge 122, a plurality of detecting columns 123, a standard column 124, and an auxiliary base 125.

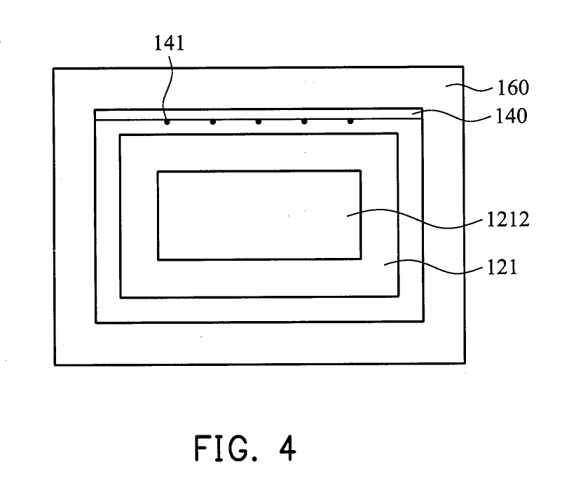

The body 121 is used as a basic element of the hand-held electrophoresis detection device 120, and is electrically coupled with the main portion 110. The body 121 includes a handle 1211 for the user to hold the hand-held electrophoresis detection device 120, and includes a slot 1212 as shown in FIG. 4 for receiving the cartridge 122 so that the cartridge 122 is disposed in the slot 1212 of the body 121 in a detachable manner. As stated above, the cartridge 122 is disposed in the slot 1212 of the body 121 in a detachable manner, and is electrically coupled to the body 121. Thus, after the detection is finished, the cartridge 122 can be quickly replaced to prevent the samples from intermixing.

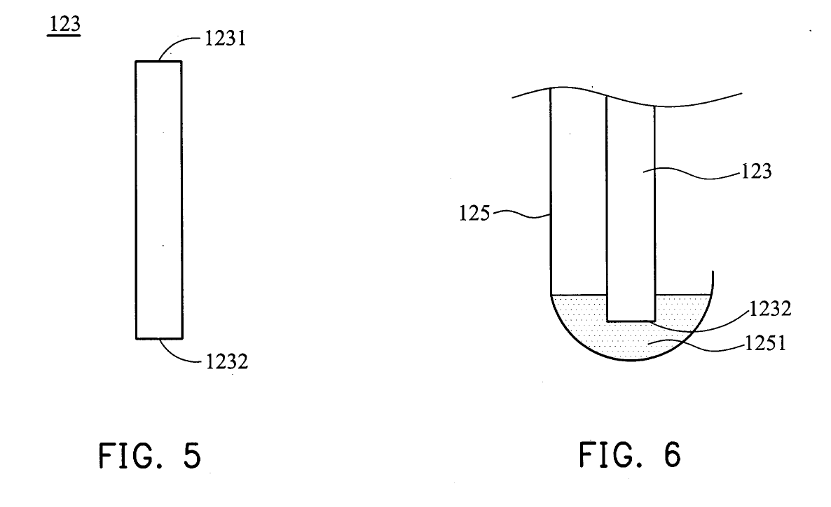

Each of the detecting columns 123 is disposed on the cartridge 122, and includes a first end 1231 and a second end 1232 as shown in FIG. 5. The first end 1231 of the detecting column 123 is disposed on the cartridge 122, and is electrically coupled to the power supply 112 via the cartridge 122 and the body 121 to have a first voltage. The second end 1232 of the detecting column 123 is electrically coupled to the power supply 112 via the auxiliary base 125 to have a second voltage. The sample is attached to the second end 1232 of the detecting column 123. Thus, the sample moves from the second end 1232 of the detecting column 123 to the first end 1231 of the detecting column 123 by a voltage differential between the first voltage and the second voltage.

The standard column 124 is disposed on the cartridge 122, and is used for comparing with the detecting column 123. Specifically, the standard column 124 is attached with a standard sample with known properties during detection. Thus, when the detecting column 123 is attached a sample to be detected, the standard column 124 can be used as a reference for the detecting column 123.

The auxiliary base 125 is disposed on the body 121 in a detachable manner. Specifically, after the sample is attached to the detecting column 123, the auxiliary base 125 is mounted on the body 121. Referring to FIG. 6, an electrically conductive liquid 1251 is filled in the auxiliary base 125 so that the second end 1232 of the detecting column 123 is electrically coupled to the power supply 112 via the auxiliary base 125.

The robot 130 is electrically coupled to the controller 1111 of the main portion 110 to move the hand-held electrophoresis detection device 120 to a predetermined position. Thus, in a specific condition, the robot 130 can replace manual operation.

Referring to FIG. 3, the sensor 140 is disposed in the body 121, and detects a movement of the sample in the detecting column 123 and the standard column 124. Furthermore, the sensor 140 may be an optical sensor or an electrochemical sensor or a biochemical sensor. In FIG. 4, the sensor 140 is an optical sensor, and comprises a plurality of photodiodes 141.

It is understood that a labeling reagent can be attached to the sample to assist the sensor 140 in detecting the sample. The labeling reagent may comprise fluorescent molecules or nanometer-scale particles or light-absorbent molecules.

Furthermore, the light source 150 provides a light when the sensor 140 detects the sample; therefore, the result of the sensor 140 can be more precise. The housing 160 protects the units inside the hand-held electrophoresis detection device 120.

It is understood that a cable or an optical fiber cable can connect the main portion 110 and the hand-held electrophoresis detection device 120 to electrically couple the main portion 110 and the hand-held electrophoresis detection device 120. Thus, the main portion 110 can communicate with the hand-held electrophoresis detection device 120; for example, the main portion 110 can send the signal to the hand-held electrophoresis detection device 120. However, every device in the apparatus 100 may be electrically coupled together in a wireless manner

Furthermore, a macromolecular material is added into the detecting column to separate the sample. It is understood that the macromolecular material can be natural or artificial.

It is also understood that a liquid or a gel or a solid material can be added into the detecting column to separate the sample. The solid material may be porous.

The structure of the electrophoresis separation apparatus is described as above, and its detection process is described as follows.

The sample is attached to the second end 1232 of the detecting column 123 of the hand-held electrophoresis detection device 120, and the standard sample is attached to the standard column 124. Then, the auxiliary base 125 is assembled to the body 121, and a predetermined data is input via the input panel 1112. The controller 1111 actuates the power supply 1112 to provide the voltage to the columns 123, 124 so that the samples move inside the columns 123, 124. When the sensor 140 detects the sample, it sends the data to the controller 1111, and the result is displayed on the display panel 1113.

It is understood that the result of the sample is determined by the time that how long the sample moves to the position of the sensor 140 in this embodiment. However, it is not limited to this manner.

In addition, in this embodiment, the standard column 124 is provided to be the reference of the detecting column 124. However, the standard column 124 may be not necessary since the reference data can be previously saved in the controller 1111.

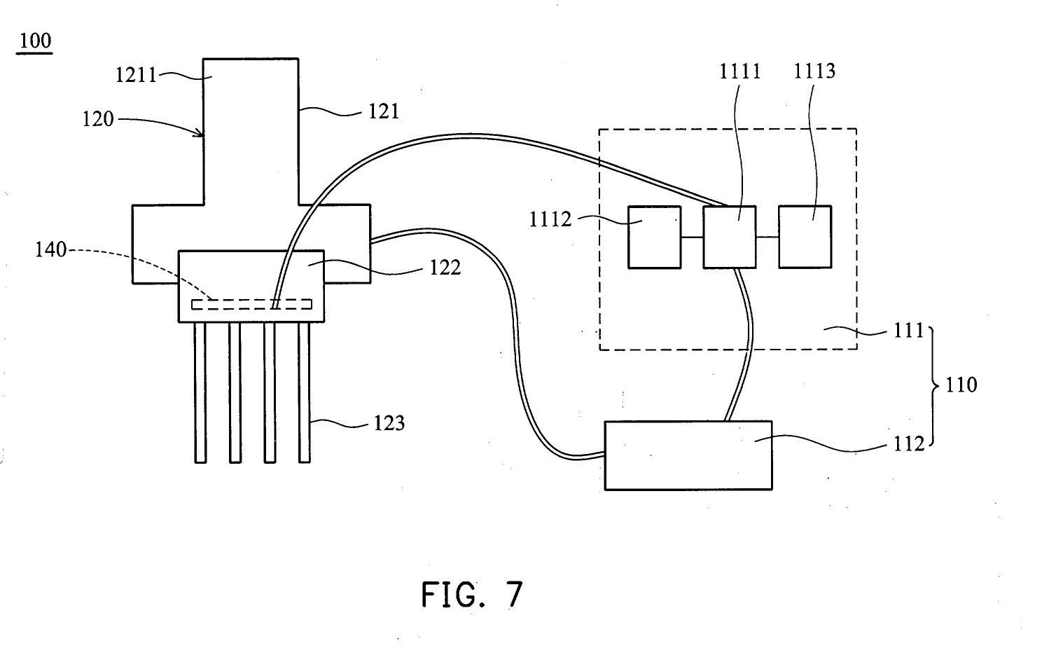

FIG. 7 is a schematic view of a variant embodiment of the electrophoresis separation apparatus in FIG. 3. In FIG. 7, the standard column 124, the auxiliary base 125, the robot 130, the light source 150, the housing 160 are omitted since they are not necessary.

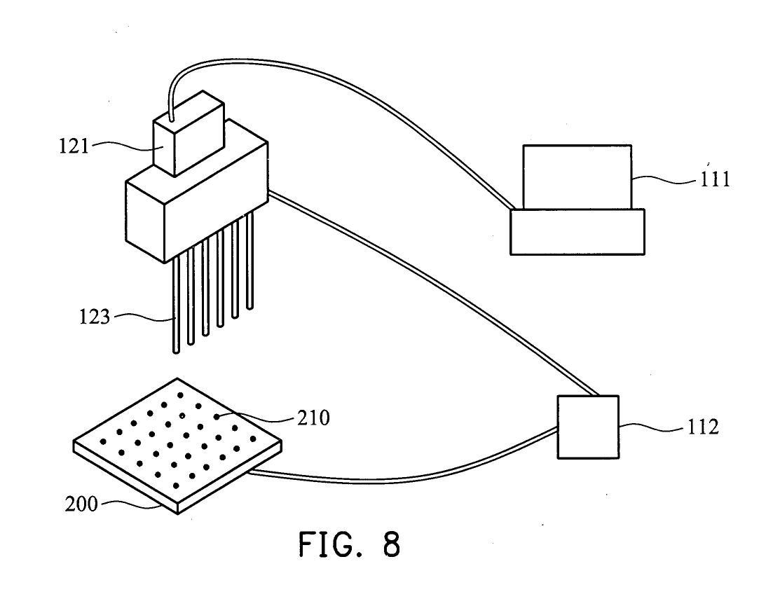

In addition, referring to FIG. 8, the electrophoresis separation apparatus 100, as disclosed in this invention, can be applied in a normal assay plate 200. During the operation, sample holes 210 of the assay plate 200 are electrically coupled to the power supply 120.

The advantages of the electrophoresis separation apparatus 100 are described as follows:

1. Since the hand-held electrophoresis detection device 120 is disposed in a manner such that it can separate from the main portion 110, the whole apparatus 100 can be minimized. Also, the operation of the hand-held electrophoresis detection device 120 is not restrained by the position of the main portion 110, the detection of the apparatus 100 is thus more simple and fast.

2. Since the cartridge 122 is disposed on the body 121 in a replaceable manner, the samples attached to the cartridge 122 can be prevented from intermixing. Furthermore, if the cartridges 122 are mass-produced, their cost can be reduced. In addition, the material for separating the sample can be previously filled in the detecting column 123 of the cartridge 122.

3. Since the sample is attached to the detecting column 123 in a dipping manner, the amount of the sample can be affectively reduced.

4. Since several columns 123 are disposed on one cartridge 122, several samples can be preceded at the same time. Thus, the process time can be reduced, and the apparatus is convenient to maintain.

5. Since the sensor 140 is disposed in the body 121, the detection of the sample can be performed in a real time manner. That is, the sample attached to the column can be directly analyzed to simplify the process.

6. Since the cartridge 122 is inserted into the slot 1212 of the body 121, the relationship between the sensor 140 and the column 123 can be precisely set without adjustment.

7. In a specific condition, instead of manual manner, the robot 130 can handle the hand-held electrophoresis detection device 120 to automatically perform the detection.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. A hand-held electrophoresis detection device, for detecting samples, comprising:
a body;
a cartridge, disposed on the body, including at least one detecting column, wherein the detecting column includes a first end and a second end, and has a first voltage at the first end and a second voltage at the second end, and the sample is attached to the second end of the detecting column, whereby the sample moves from the second end to the first end through the detecting column by a voltage differential between the first voltage and the second voltage; and
a sensor, disposed in the body, for detecting a movement of the sample in the detecting column.

2. The hand-held electrophoresis detection device as claimed in claim 1, wherein the body includes a slot for receiving the cartridge so that the cartridge is disposed in the slot of the body in a detachable manner.

3. The hand-held electrophoresis detection device as claimed in claim 1, wherein the sensor is an optical sensor.

4. The hand-held electrophoresis detection device as claimed in claim 3, wherein the sensor comprises a photodiode.

5. The hand-held electrophoresis detection device as claimed in claim 1, wherein a labeling reagent is attached to the sample to assist the sensor in detecting the sample.

6. The hand-held electrophoresis detection device as claimed in claim 5, wherein the labeling reagent comprises fluorescent molecules, nanometer-scale particles, or light-absorbent molecules.

7. The hand-held electrophoresis detection device as claimed in claim 1, wherein the cartridge includes a standard column for comparing with the detecting column.

8. The hand-held electrophoresis detection device as claimed in claim 1, wherein the first end of the detecting column is electrically coupled to the body to carry the first voltage.

9. The hand-held electrophoresis detection device as claimed in claim 1, further comprising:
an auxiliary base disposed on the body in a detachable manner.

10. The hand-held electrophoresis detection device as claimed in claim 9, wherein the second end of the detecting column is electrically coupled to the auxiliary base to carry the second voltage.

11. An electrophoresis separation apparatus, for detecting samples, comprising:
a main portion for controlling a detection of the sample; and
a hand-held electrophoresis detection device, connected with the main portion in a separable manner, including at least one detecting column, wherein the detecting column includes a first end and a second end, and has a first voltage at the first end and a second voltage at the second end, and the sample is attached to the second end of the detecting column, whereby the sample moves from the second end to the first end through the detecting column by a voltage differential between the first voltage and the second voltage.

12. The electrophoresis separation apparatus as claimed in claim 11, wherein the main portion comprises:
a power supply, electrically coupled to the detecting column, for providing the first voltage and the second voltage; and
a controller electrically coupled to the power supply to control power supply.

13. The electrophoresis separation apparatus as claimed in claim 12, wherein the main portion further comprises:
an input panel, electrically coupled to the controller, for inputting data; and
a display, electrically coupled to the controller, for displaying the data.

14. The electrophoresis separation apparatus as claimed in claim 13, wherein the controller, the input panel, and the display are replaced by a computer.

15. The electrophoresis separation apparatus as claimed in claim 11, further comprising:
a robot electrically coupled to the main portion to move the hand-held electrophoresis detection device to a predetermined position.

16. The electrophoresis separation apparatus as claimed in claim 11, wherein the hand-held electrophoresis detection device includes a standard column for comparing with the detecting column.

17. The electrophoresis separation apparatus as claimed in claim 11, wherein the hand-held electrophoresis detection device comprises:
a body electrically coupled with the main portion;
a cartridge, disposed on the body, including the detecting column; and
a sensor, disposed in the body, for detecting a movement of the sample in the detecting column.

18. The electrophoresis separation apparatus as claimed in claim 17, wherein the sensor is an optical sensor.

19. The electrophoresis separation apparatus as claimed in claim 15, wherein the sensor comprises a photodiode.

20. The electrophoresis separation apparatus as claimed in claim 17, wherein a labeling reagent is attached to the sample to assist the sensor in detecting the sample.

21. The electrophoresis separation apparatus as claimed in claim 20, wherein the labeling reagent comprises fluorescent molecules, nanometer-scale particles, or light-absorbent molecules.

22. The electrophoresis separation apparatus as claimed in claim 17, further comprising:
a light source for providing a light when the sensor detects the sample.

23. The electrophoresis separation apparatus as claimed in claim 17, wherein the body includes a slot for receiving the cartridge so that the cartridge is disposed in the slot of the body in a detachable manner.

24. The electrophoresis separation apparatus as claimed in claim 17, wherein the first end of the detecting column is electrically coupled to the body to carry the first voltage.

25. The electrophoresis separation apparatus as claimed in claim 17, wherein the hand-held electrophoresis detection device further comprises:
an auxiliary base disposed on the body in a detachable manner.

26. The electrophoresis separation apparatus as claimed in claim 25, wherein the second end of the detecting column is electrically coupled to the auxiliary base to carry the second voltage.

27. An electrophoresis separation apparatus, for detecting samples, comprising:
a power supply;
a controller electrically coupled to the power supply to control power supply;
a body electrically coupled to the power supply and connected with the controller in a separable manner;
a cartridge, disposed on the body, including at least one detecting column, wherein the detecting column includes a first end and a second end, and has a first voltage at the first end and a second voltage at the second end, and the sample is attached to the second end of the detecting column, whereby the sample moves from the second end to the first end through the detecting column by a voltage differential between the first voltage and the second voltage; and
a sensor, disposed in the body, for detecting a movement of the sample in the detecting column.

28. The electrophoresis separation apparatus as claimed in claim 27, further comprising:
an input panel, electrically coupled to the controller, for inputting data; and
a display, electrically coupled to the controller, for displaying the data.

29. The electrophoresis separation apparatus as claimed in claim 28, wherein the controller, the input panel, and the display are replaced by a computer.

30. The electrophoresis separation apparatus as claimed in claim 27, further comprising:
a robot electrically coupled to the main portion to move the hand-held electrophoresis detection device to a predetermined position.

31. The electrophoresis separation apparatus as claimed in claim 27, wherein the sensor is an optical sensor.

32. The electrophoresis separation apparatus as claimed in claim 31, wherein the sensor comprises a photodiode.

33. The electrophoresis separation apparatus as claimed in claim 27, wherein a labeling reagent is attached to the sample to assist the sensor in detecting the sample.

34. The electrophoresis separation apparatus as claimed in claim 33, wherein the labeling reagent comprises fluorescent molecules, nanometer-scale particles, or light-absorbent molecules.

35. The electrophoresis separation apparatus as claimed in claim 27, further comprising:
a light source for providing a light when the sensor detects the sample.

36. The electrophoresis separation apparatus as claimed in claim 27, wherein the body includes a standard column for comparing with the detecting column.

37. The electrophoresis separation apparatus as claimed in claim 27, wherein the body includes a slot for receiving the cartridge so that the cartridge is disposed in the slot of the body in a detachable manner.

38. The electrophoresis separation apparatus as claimed in claim 27, wherein the first end of the detecting column is electrically coupled to the body to carry the first voltage.

39. The electrophoresis separation apparatus as claimed in claim 27, wherein the hand-held electrophoresis detection device further comprises:
an auxiliary base disposed on the body in a detachable manner.

40. The electrophoresis separation apparatus as claimed in claim 39, wherein the second end of the detecting column is electrically coupled to the auxiliary base to carry the second voltage.
